(19) United States
(12) Patent Application Publication
(10) Pub. No.: US 2009/0123866 A1
(43) Pub. Date: May 14, 2009

(54) Method For Producing Toner

(75) Inventors: Masateru KAWAMURA, Toyoake-shi (JP); Jun IKAMI, Nagoya-shi (JP); Takanori UNO, Nagoya-shi (JP); Tomoaki HATTORI, Nagoya-shi (JP)

Correspondence Address: BANNER & WITCOFF, LTD.;ATTORNEYS FOR CLIENT NO. 016689, 1100 13th STREET, N.W., SUITE 1200, WASHINGTON, DC, 20005-4051, US

(73) Assignee: BROTHER KOGYO KABUSHIKI KAISHA, Nagoya-shi (JP)

(21) Appl. No.: 12/267,695

(22) Filed: Nov. 10, 2008

(30) Foreign Application Priority Data
Nov. 9, 2007 (JP) 2007-292141

(51) Int. Cl. G03G 9/087

(52) U.S. Cl. 430/137.14; 430/137.22

(57) ABSTRACT

A method for producing toner is described. In the method for producing a toner, a resin liquid is prepared by mixing at least a binder resin made of polyester resin and a colorant with an organic solvent, the resin liquid is dispersed in an aqueous medium to form an emulsion, and the organic solvent is removed from the emulsion to produce a toner. The organic solvent before preparation of the resin liquid contains 5 to 20 parts by weight of water per 100 parts by weight of the organic solvent.

### CROSS REFERENCE TO RELATED APPLICATION

This application claims priority to Japanese Patent Application No. 2007-292141 filed on Nov. 9, 2007, the disclosure of which is hereby incorporated into the present application by reference.

### TECHNICAL FIELD

The present invention relates to a method for producing a toner used in electrophotography, electrostatic recording, and other imaging techniques.

### BACKGROUND

As the method for producing a toner, there has been known an emulsification/dispersion method including mixing and emulsifying a mixture containing a binder resin and a colorant with an aqueous medium to obtain toner particles.

The emulsification/dispersion method has advantages such that it is easy to cope with reduction in toner particle size and formation of spherical toner particles; the selection range of binder resins is broadened, as compared with polymerization method; in addition, residual monomers can be easily reduced; and the concentration of colorant can be optionally changed.

For example, there has been proposed a method including kneading a mixture containing a polyester resin and a colorant, dispersing the kneaded chip thus obtained in an organic solvent to prepare a resin solution, mixing and emulsifying the resin solution with an aqueous medium, thereafter, removing the organic solvent from the emulsified mixture, aggregating fine particles and further associating to form an aggregate of the fine particles by fusion, to obtain toner particles. In this proposal, methyl ethyl ketone, which is soluble in water, is used as an organic solvent.

However, in the above method, when the resin solution is mixed with the aqueous medium, an abrupt phase change may occur, so that the colorant is poorly dispersed and the resin dissolved in the resin solution is precipitated, thereby deteriorating the toner characteristics.

In the above method, such abrupt phase change is suppressed by adding a small amount of the aqueous medium step by step to the resin solution by phase inversion emulsification. The phase inversion emulsification, however, requires enormous time to add a small amount of the aqueous medium step by step.

### SUMMARY

One aspect of the present invention may provide a method for producing a toner, capable of preventing poor dispersion of a colorant and precipitation of a resin dissolved in a resin solution, improving toner characteristics, and also improving productivity, by a simple method.

The same or different aspect of the present invention may provide a method for producing a toner including the steps of preparing a resin liquid by mixing at least a binder resin made of polyester resin and a colorant with an organic solvent; dispersing the resin liquid in an aqueous medium to form an emulsion; and removing the organic solvent from the emulsion to produce a toner, in which the organic solvent before preparation of the resin liquid contains 5 to 20 parts by weight of water per 100 parts by weight of the organic solvent.

### DETAILED DESCRIPTION

In the following, one embodiment of the method for producing the toner of one or more aspects of the present invention will be explained.

### 1) Step of Preparing an Oil Medium

In this method, first, 5 to 20 parts by weight of water is mixed with 100 parts by weight of an organic solvent to prepare an oil medium.

### (Organic Solvent)

No particular limitation is imposed on the organic solvent as long as water is compatible therewith at 25° C., and an organic solvent which dissolves a binder resin and a wax, both described later, is preferable.

Examples of the organic solvent include ketones such as acetone, methyl ethyl ketone (MEK), methyl propyl ketone, methyl butyl ketone, methyl isobutyl ketone and diethyl ketone; glycols such as ethylene glycol, diethylene glycol, methyl cellosolve, ethyl cellosolve, methyl carbitol and ethyl carbitol; and ethers such as tetrahydrofuran (THF). These organic solvents can be used alone or in combination.

Among them, ketones are preferable, and specifically, methyl ethyl ketone may be used. Further, ethers are preferable, and specifically, tetrahydrofuran may be used.

### (Preparation of Oil Medium)

For preparation of the oil medium, for example, water is mixed with the organic solvent so that the amount of water is in the range of 5 to 20 parts by weight, or preferably 5 to 15 parts by weight, per 100 parts by weight of the organic solvent, and the mixture is then blended together. Thus, an oil medium is prepared as a homogeneous solution.

In the case of using an organic solvent which can not dissolve over 20 parts by weight of water in 100 parts by weight of the organic solvent, water is mixed in an certain amount (hereinafter described as saturation dissolving amount) or less that produces a saturated solution when mixed with 100 parts by weight of the organic solvent with 100 parts by weight of the organic solvent. For example, when methyl ethyl ketone is used as the organic solvent, water is mixed in an amount of 5 parts by weight or more and the saturation dissolving amount or less, with 100 parts by weight of methyl ethyl ketone, and then blended together.

When the amount of water is less than this range, an abrupt phase change may not be able to be suppressed in a step of preparing an emulsion. On the contrary, when the amount of water is more than this range, a colorant may be aggregated or a wax may be precipitated in a step of preparing a resin liquid to be described later, whereby the printing characteristics of toner may be deteriorated.

In the case where the organic solvent for preparation originally contains water, when the water content of the organic solvent corresponds to the above proportional range, the organic solvent can be used as it is, or when the water content of the organic solvent is less than that, water is added to the organic solvent to be adjusted to the above proportional range.

### 2) Step of Preparing a Resin Liquid

Next, in this method, at least, a binder resin made of polyester resin, a colorant, and, if necessary, a wax, a charge-controlling agent and the oil medium described above are mixed to prepare a resin liquid.

### (Binder Resin)

The binder resin is a main component of the toner and is made of a synthetic resin which fixes (heat-seals) on the surface of a recording medium (e.g., paper sheet or OHP sheet) through heating and/or pressure application. According to the present invention, such binder resin is made of polyester resin.

It is preferable that the binder resin made of polyester resin has a hydrophilic group. The hydrophilic group can eliminate the need for mixing of a surfactant during preparation of an emulsion to be described later. Examples of the hydrophilic group include cationic groups such as a quaternary ammonium group, a quaternary ammonium salt-containing group, an amino group and a phosphonium salt-containing group; and anionic groups such as a carboxyl group and a sulfonic acid group.

A polyester resin having an anionic group is preferable, and a polyester resin having a carboxyl group (polyester resin having an acid value) is more preferable.

The polyester resin having a carboxyl group described above is commercially available, and for example, a polyester resin having an acid value of 0.5 to 40 mg KOH/g, or preferably 1.0 to 20 mg KOH/g; a weight-average molecular weight (determined by GPC using a calibration curve of standard polystyrene) of 9,000 to 200,000, or preferably 20,000 to 150,000; a crosslinked fraction (THF insoluble fraction) of 10% by weight or less, or preferably 0.5 to 10% by weight; and a glass transition point (Tg) of 50 to 70° C., or preferably 55 to 65° C., is used.

When the acid value is lower than this range, the polyester resin is less reacted with a base such as sodium hydroxide to be added later, so that emulsification becomes unstable, which may fail to obtain a stable slurry. On the contrary, when the acid value is higher than this range, the chargeability of the toner becomes excessively high, which may lower the image density.

When the weight-average molecular weight is lower than this range, the mechanical strength of the toner becomes insufficient, which may decrease the durability of the toner. On the contrary, when the weight-average molecular weight is higher than this range, the melt viscosity of the toner becomes excessively high, so that emulsion droplets become larger, whereby coarse particles may easily be produced.

Although no crosslinked fraction is necessary, it is preferable that some crosslinked fractions exist for the strength or fixation (particularly, offset on the high-temperature side) of the toner. However, excessive crosslinked fractions may increase the size of the emulsion droplet, whereby coarse particles may be produced.

### (Colorant)

The colorant imparts a desired color to the toner, and is dispersed or permeated into the binder resin. Examples of the colorant include carbon black; organic pigments such as Quinophthalone Yellow, Hansa Yellow, Isoindolinone Yellow, Benzidine Yellow, Perynone Orange, Perynone Red, Perylene Maroon, Rhodamine 6G Lake, Quinacridone Red, Rose Bengal, Copper Phthalocyanine Blue, Copper Phthalocyanine Green and a diketopyrrolopyrrole pigment; inorganic pigments or metal powders such as a Titanium White, Titanium Yellow, Ultramarine Blue, Cobalt Blue, red iron oxide, aluminium powder and bronze; oil-soluble dyes or dispersion dyes such as azo dyes, quinophthalone dyes, anthraquinone dyes, xanthene dyes, triphenylmethane dyes, phthalocyanine dyes, indophenol dyes and indoaniline dyes; and rosin dyes such as rosin, rosin-modified phenol and rosin-modified maleic acid resin. Further, other dyes and pigments treated with higher fatty acid or resin may be used.

These can be used alone or in combination corresponding to a desired color. For example, when a mono-chromatic color toner is provided, the colorant can be prepared by mixing a pigment and a dye of the same color; for example, rhodamine pigment and dye, quinophthalone pigment and dye, or phthalocyanine pigment and dye.

### (Wax)

The wax is added in order to improve fixation of the toner to a recording medium. In the case of a thermal pressure fixing system, it is common to include wax in the inner portion of the toner so as to facilitate peeling of the toner from a heating medium. Examples of the wax include ester waxes and hydrocarbon waxes.

Examples of the ester wax include aliphatic ester compounds such as stearate and palmitate; and polyfunctional ester compounds such as pentaerythritol tetramyristate, pentaerythritol tetrapalmitate and dipentaerythritol hexapalmitate.

Examples of the hydrocarbon wax include polyolefine waxes such as low-molecular weight polyethylene, low-molecular weight polypropylene and low-molecular weight polybutylene; plant-derived natural waxes such as candelilla wax, carnauba wax, rice wax, Japan wax and Jojoba wax; petroleum waxes and modified waxes thereof such as paraffin, microcrystalline and petrolatum; and synthetic waxes such as Fischer-Tropsch wax.

These waxes can be used alone or in combination. Among the above waxes, a wax having a melting point of 50 to 100° C. is preferable. Even when a fuser has a low heating temperature, a wax having a low melting point and a low melt viscosity melts before the binder resin melts and then exude from the surface of the toner, which can prevent offset. More specific examples of the wax include ester waxes and paraffin waxes.

### (Charge-Controlling Agent)

The charge-controlling agent can be added as required. A known charge-controlling agent can be used, and examples of the positively chargeable charge-controlling agent include nigrosine dye, quaternary ammonium compound and basic group-containing compound; and other polymer compounds such as tertiary amino group-containing acrylic resin and compounds having a functional group of quaternary ammonium salt. Examples of the negatively chargeable charge-controlling agent include trimethyl ethane dyes, azo dyes, copper phthalocyanine, metal salicylate complex, metal benzilate complex, perylene, Quinacridone and metal complex azo dyes.

### (Preparation of Resin Liquid)

The resin liquid is prepared in the form of a solution or a dispersion by mixing a binder resin made of polyester resin and a colorant, if necessary, a wax and a charge-controlling agent, with an oil medium.

For preparation of the resin liquid, for example, the binder resin made of polyester resin, the colorant and, if necessary, the wax and the charge-controlling agent are mixed in the oil medium so that the amount of the binder resin made of polyester resin is in the range of 5 to 40 parts by weight, or preferably 10 to 30 parts by weight, the amount of the colorant is in the range of 0.25 to 3 parts by weight, or preferably 0.5 to 2 parts by weight, if necessary, the amount of the wax is in the range of 0.25 to 4 parts by weight, or preferably 0.5 to 3 parts by weight, and if necessary, the amount of the charge-controlling agent is in the range of 0.01 to 4 parts by weight, or preferably 0.05 to 3 parts by weight, per 100 parts by weight of the oil medium, and the mixture is then blended together.

When the resin liquid contains the wax, the wax is dissolved in the organic solvent by mixing and blending each of the components together, and then heating the mixture at a heating temperature higher than a wax dissoluble temperature and less than the boiling point of the organic solvent, specifically, although the temperature depends on the type of wax or organic solvent, for example, at a temperature exceeding 30° C., or preferably from 32 to 79° C.

The colorant can be mixed with the resin liquid by preliminarily dispersing the colorant in the organic solvent to prepare a colorant dispersion, and then mixing the colorant dispersion with the oil medium. In this preparation, in order to disperse the colorant, a dispersing agent or a binder resin in place of the dispersing agent, can be added. Preferably, a binder resin is added.

For preparation of the colorant dispersion, for example, the colorant, the binder resin made of polyester resin and the organic solvent are mixed so that the amount of the binder resin made of polyester resin is in the range of 50 to 200 parts by weight, or preferably 80 to 150 parts by weight, and the amount of the organic solvent is in the range of 300 to 1000 parts by weight, or preferably 300 to 900 parts by weight, per 100 parts by weight of the colorant, the mixture is preliminarily dispersed with an agitator (e.g., a disper and a homogenizer), and the dispersion is then finely dispersed with a dispersing apparatus (e.g., a bead mill and a high-pressure homogenizer).

### 3) Step of Preparing an Emulsion

Next, in this method, an aqueous medium and the resin liquid are mixed to prepare an emulsion.

### (Aqueous Medium)

The aqueous medium is water or an aqueous medium containing water serving as a main component in which some additive (e.g., a surfactant and a dispersing agent) is mixed. For example, when a binder resin having an anionic group is used, an alkaline aqueous solution is mixed in the aqueous medium. Examples of the alkaline aqueous solution include an organic basic solution in which a basic organic compound such as amines is dissolved in water; and an inorganic basic solution in which alkali metal is dissolved in water, such as an aqueous sodium hydroxide solution and an aqueous potassium hydroxide solution.

The inorganic basic solution is prepared in the form of an aqueous sodium hydroxide solution or an aqueous potassium hydroxide solution having a normality of 0.1 to 5, or preferably 0.2 to 2. When a wax that is difficult to dissolve in a resin solution due to mixing of water is mixed, an organic base aqueous solution is preferably used from the viewpoint of preventing the precipitation of the wax.

For preparation of the aqueous medium, for example, an inorganic basic solution is mixed with water so that the amount of the inorganic basic solution is in the range of 0.1 to 40 parts by weight, or preferably 1 to 20 parts by weight, per 100 parts by weight of water.

Further, for preparation of the aqueous medium, for example, an organic basic solution is mixed with water so that the amount of the organic basic solution is in the range of 0.5 to 20 parts by weight, or preferably 1 to 10 parts by weight, per 100 parts by weight of water.

If necessary, an organic solvent is mixed in the aqueous medium. By doing so, water and an organic solvent are mixed in the oil medium and the aqueous medium, respectively, so that an abrupt phase change can be further suppressed in the step of preparing an emulsion.

No particular limitation is imposed on the organic solvent mixed in the aqueous medium, and for example, the organic solvent exemplified in the preparation of the oil medium as described above is used.

The organic solvent is mixed with water so that the amount of the organic solvent is in the range of 1 to 30 parts by weight, or preferably 5 to 10 parts by weight, per 100 parts by weight of water.

### (Preparation of Emulsion)

For preparation of the emulsion, the resin liquid is mixed with the aqueous medium so that the amount of the resin liquid is in the range of, for example, 50 to 150 parts by weight, or preferably 80 to 120 parts by weight, per 100 parts by weight of the aqueous medium.

When a wax is contained in the resin liquid, the resin liquid and the aqueous medium are heated at a temperature in the range of a temperature capable of dissolving the wax or more and less than the boiling point of the organic solvent, for example, 30 to 80° C., or preferably 40 to 70° C., and then mixed together while the heating temperature is maintained.

Thereafter, the aqueous medium mixed with the resin liquid is agitated while the heating temperature is maintained. The agitation is performed using turbine blades or propeller blades in an agitator such as a three-one motor, for example. In order to make an emulsion droplet smaller, a high-speed dispersing apparatus such as a homogenizer is used. Other dispersing apparatuses such as a high-pressure homogenizer can also be used. In the case of using a rotor-stator type agitator such as a homogenizer, agitation is performed at a tip peripheral speed of 5 to 20 m/s, or preferably 7 to 14 m/s for 10 to 120 minutes, or preferably for 15 to 60 minutes. This then forms the resin liquid into liquid droplets having a size of 100 to 1000 nm to be emulsified in the aqueous medium, so that an emulsion is prepared.

In the emulsification, the resin liquid may be mixed with the aqueous medium, and vice versa. When the aqueous medium is mixed with the resin liquid, a phase inversion emulsification method can also be used. Generally, the phase inversion emulsification method requires enormous time to add a small amount of the aqueous medium step by step to the resin liquid. According to the present invention, however, the addition rate of the aqueous medium can be increased, so that productivity can be improved.

When the binder resin having an anionic group is used, an alkaline aqueous solution is preliminarily mixed with the resin liquid to be neutralized and water may be mixed therewith, or further, water can also be mixed with the resin liquid which has preliminarily been neutralized.

### 4) Step of Preparing a Suspension

Next, in this method, the organic solvent is removed from the emulsion to obtain a suspension. To remove the organic solvent from the emulsion, a known method such as ventilation, heating, decompression or combination thereof is employed. For example, the emulsion is heated under inert gas atmosphere, for example, at a temperature of room temperature to 90° C., or preferably 65 to 80° C. until about 80 to 95% by weight of the early amount of the organic solvent is removed. The organic solvent is then removed from the aqueous medium, so that a suspension (slurry) having resin microparticles of the binder resin, in which the colorant and the wax are homogeneously dispersed, dispersed in the aqueous medium is prepared.

In the obtained suspension, the solid content in the suspension (concentration of the resin microparticles in the suspension) is in the range of, for example, 5 to 50% by weight, or preferably 10 to 30% by weight. The resin microparticles dispersed in the aqueous medium have a volume average particle diameter of, for example, 30 to 1000 nm, or preferably 50 to 500 nm, as a median size.

The suspension is further diluted with water and is adjusted so that the solid content is in the range of, for example, 1 to 30% by weight, or preferably 5 to 20% by weight.

In this dilution, if necessary, a surfactant can be added together with the aqueous medium in order to achieve dispersion stability in an aggregation/fusion step.

Examples of the surfactant include polyoxyethylene polyoxypropylene glycol, polyoxyalkylene decyl ether, polyoxyalkylene tridecyl ether, polyoxyethylene isodecyl ether, polyoxyalkylene lauryl ether and polyoxyethylene alkyl ether. Among them, polyoxyethylene polyoxypropylene glycol is preferable.

In the case of adding a surfactant to the suspension, for example, the surfactant is mixed with the suspension so that the amount of the surfactant is in the range of 0.5 to 20 parts by weight, or preferably 1 to 10 parts by weight, per 100 parts by weight of the solid content of the suspension.

### 5) Aggregation/Fusion Step

Next, in this method, a flocculant is added to the suspension to aggregate resin microparticles, then heating the aggregated resin microparticles to be fused (heat sealed), so that the particle size of the resin microparticle is grown, whereby toner base particles are obtained.

Examples of the flocculant include inorganic metal salts such as aluminium chloride and calcium nitrate; and inorganic metal salt polymers such as polyaluminium chloride.

In the aggregation process, the aqueous flocculant solution prepared to have a normality of, for example, 0.01 to 1.0, or preferably 0.05 to 0.5 is added to the suspension so that the amount of the aqueous flocculant solution is in the range of, for example, 0.1 to 10 parts by weight, or preferably 0.5 to 5 parts by weight, per 100 parts by weight of the suspension, and the mixture is then agitated.

No particular limitation is imposed on the agitation, and for example, first, the suspension is dispersed using a high-speed dispersing apparatus such as a homogenizer, and then mixed using an agitator with agitating blades to an extent that the entire suspension flows. Known agitating blades such as flat turbine blades, propeller blades, or anchor blades can be used. Further, the agitation can be performed with an ultrasonic dispersing apparatus. The solution temperature during dispersion is, for example, from 10 to 50° C., or preferably from 20 to 30° C., and the agitation time is, for example, from 5 to 60 minutes, or preferably from 10 to 30 minutes.

Thereafter, it is preferable that the suspension is homogeneously aggregated by heating. The heating temperature is increased to, for example, about a temperature at which the particles are not fused, such as from 35 to 60° C. Then, an aggregation terminator is added thereto to complete the aggregation step, and the resin microparticles thus aggregated are then fused by heating.

Examples of the aggregation terminator include alkali metals such as sodium hydroxide and potassium hydroxide. An ionic surfactant can also be used.

In the addition process of the aggregation terminator, the aqueous alkali metal solution prepared to have a normality of 0.01 to 5.0, or preferably 0.1 to 2.0 is added to the suspension so that the amount of the aqueous alkali metal solution is in the range of, for example, 0.5 to 20 parts by weight, or preferably 1.0 to 10 parts by weight, per 100 parts by weight of the suspension and the agitation of the mixture is then continued.

Thereafter, fusion is performed by heating the mixture at a temperature of the glass transition point (Tg) of the resin or more, for example, from 55 to 100° C., or preferably 65 to 95° C. while the above-mentioned agitation is continued. The heating time may be until the particles are fused into a desired shape, for example, from 0.5 to 10 hours, although depending on the type of resin. When the heating time is shortened, unusual-shaped toner base particles can be obtained. When heating is further continued, spherical-shaped toner base particles can be obtained. Thus, the resin microparticles thus aggregated are fused, whereby toner base particles having a volume average diameter of, for example, 3 to 12 μm, or preferably 6 to 10 μm are obtained.

Thereafter, the toner base particles thus obtained are cooled, reverse-neutralized with an acid, filtered and dried to obtain powders of the toner base particles.

In the reverse-neutralization, for example, an inorganic acid such as hydrochloric acid, sulfuric acid or nitric acid is used to prepare, for example, a 0.01 to 5 N (normal) aqueous solution, or preferably a 0.1 to 2 N (normal) aqueous solution, and the obtained solution is added to the suspension so that the amount of the solution is in the range of, for example, 0.05 to 2 parts by weight, or preferably 0.1 to 1 part by weight, per 100 parts by weight of the suspension. Then, the mixture is agitated for 10 to 180 minutes, or preferably for 15 to 120 minutes to an extent that the suspension flows.

### 6) Mixing of an Additive

An external additive or the like is added as required to the toner base particle thus obtained to thereby obtain a desired toner.

### (Addition of External Additive(s))

The external additive is added in order to adjust charging characteristics, flowability, storage stability, etc., of the toner, and is in the form of ultra-microparticles considerably smaller than the toner base particles.

Examples of the external additive include inorganic particles and synthetic resin particles.

Examples of the inorganic particle include silica, aluminum oxide, titanium oxide, silicon aluminium oxide, silicon titanium oxide and a hydrophobicized product thereof. For example, a hydrophobicized product of silica can be obtained under hydrophobicizing treatment of silica micropowder using silicone oil or a silane coupling agent (e.g., dichlorodimethylsilane, hexamethyldisilazane, tetramethyldisilazane, etc.).

Examples of the synthetic resin particles include methacrylate ester polymer particles, acrylic ester polymer particles, styrene-methacrylate ester copolymer particles, styrene-acrylate ester copolymer particles, and core-shell particles (core: styrene polymer, shell: methacrylate ester polymer).

For example, the external additive(s) and the toner base particles are mixed with stirring by means of a high-speed agitator such as a Henschel mixer and a mechanomill. The external additive is added to the toner base particles so that the amount of the external additive is in the range of, for example, 0.1 to 6 parts by weight per 100 parts by weight of the toner base particles.

### 7) Toner

The toner obtained by the above method is a positively-chargeable or a negatively-chargeable, non-magnetic single-component toner, and has a volume-average particle diameter of, for example, 3 to 12 μm, or preferably 6 to 10 μm, as a median size.

According to the above method, the oil medium is prepared by mixing water with an organic solvent at a specific ratio, so that, in the step of preparing an emulsion, even if the resin liquid was mixed with the aqueous medium, an abrupt phase change can be suppressed. This can therefore prevent poor dispersion of the colorant and precipitation of the resin and the wax dissolved in the resin liquid, due to the abrupt phase change. Thus, when the resin microparticles are aggregated and fused by heating to form a toner, a toner with the colorant homogeneously dispersed can be obtained, thereby achieving improvement of the toner characteristics such as improvement in image density.

### 8) Variation

In the above method, the resin liquid and the aqueous medium are mixed to prepare the emulsion, and thereafter the organic solvent was removed therefrom in the step of preparing a suspension. However, for example, the aggregation/fusion step may be performed without removing the organic solvent in the step of preparing a suspension. In this case, aggregation/fusion is performed to form a liquid droplet having a toner size, and thereafter, the organic solvent is removed from the emulsion by a method such as ventilation, heating or decompression.

### EXAMPLES

The above method for producing a toner will now be more particularly described by reference to the following examples and comparative examples. In the following description, the units “part(s)” and “%” are by weight, unless otherwise noted.

Each physical property is determined by the following method: Volume average diameter of the resin microparticle in the suspension: A nanotrack particle size analyzer (UPA150; manufactured by Nikkiso Co., Ltd.) was used. Pure water was employed as dilution solvent. The refractive index of the solvent and that of the dispersion were set to 1.33 and 1.9, respectively, and the same sample was then measured 3 times to thereby obtain the average value as an average median size.

### Examples 1 to 3

### Preparation of Colorant Dispersion

20 parts of Polyester resin FC1565 (Tg (glass transition point): 64° C.; Mn (number-average molecular weight): 5000; Mw (weight-average molecular weight) 98000; crosslinked fraction (THF insoluble fraction): 1.5% by weight; acid value: 6.1 mg KOH/g; manufactured by Mitsubishi Rayon Co., Ltd.), 20 parts of carbon black #260 (manufactured by Mitsubishi Chemical Corporation), and 60 parts of methyl ethyl ketone were mixed, and the mixture was preliminarily dispersed with a homogenizer DIAX 900 (manufactured by Heidolph Instruments).

Next, the dispersed mixture was finely dispersed with a beads mill (using φ 0.8 mm zirconia beads) to prepare a colorant dispersion. The colorant dispersion was found to have a solid content of 39.8%.

### (Preparation of Oil Medium)

Separately, methyl ethyl ketone (MEK) and pure water were mixed at a ratio shown in Table 1 to prepare an oil medium. The number of parts by weight of water (number of parts of water) per 100 parts by weight of methyl ethyl ketone is also shown in Table 1.

### (Preparation of Resin Liquid)

The entire amount of the oil medium was slowly supplied into 45 g of the colorant dispersion to an extent that the carbon black was not aggregated and then mixed.

Subsequently, 153 g of polyester resin (FC1565), 9 g of wax (ester wax: UNISTER H476; manufactured by NOF Corporation) and 9 g of a charge-controlling agent (nigrosine dye: BONTRON N-04; manufactured by Orient Chemical Industries, Ltd.) were supplied into the mixed solution to prepare a resin liquid.

### (Preparation of Aqueous Medium)

Separately, 9 g of a 1 N aqueous sodium hydroxide solution was mixed with pure water to prepare an aqueous medium.

The amount of the pure water was adjusted so as to make up a total amount of 900 g including the amount of pure water in the resin liquid.

### (Preparation of Emulsion)

The entire amount of the resin liquid and the entire amount of the aqueous medium each were heated to 50° C. and then mixed together in a 2-L beaker.

Thereafter, the mixture was agitated with a homogenizer DIAX 900 (manufactured by Heidolph Instruments) at 16000 rpm for 20 minutes to prepare an emulsion.

### (Preparation of Suspension)

The obtained emulsion was transferred to a 2-L separable flask, and then heated to 60° C. to volatilize and remove methyl ethyl ketone, whereby a suspension with resin microparticles dispersed in water was obtained.

The resin microparticle in the suspension thus obtained was found to have a volume average diameter (median size) of 304 to 310 nm, and the suspension was found to have a solid content of 23.5% by weight to 24.0% by weight.

60 g of an aqueous solution containing 5% polyoxyethylene polyoxypropylene glycol (Epan 750: manufactured by Dai-Ichi Kogyo Seiyaku Co., Ltd.), 800 g of a suspension prepared to have a solid content of 20% by weight, and 740 g of pure water were mixed in a 2-L separable flask, whereby a suspension having a solid content of 10% by weight was prepared.

### (Preparation of Toner Base Particle)

40 g of a 0.2 N aqueous aluminium chloride solution was added to 1600 g of a suspension and then mixed with a homogenizer at a high speed for 10 minutes. Thereafter, the suspension was heated to 45° C. in a water bath while being subjected to agitation with a turbine-mixer having 6 flat blades at 300 rpm, and the agitation was continued for 20 minutes.

Then, 40 g of a 0.2 N aqueous sodium hydroxide solution was added to the suspension and the mixture was heated to 90° C. The agitation was continued for about 5 hours until the toner base particles were formed in a spherical shape. Then, the suspension was cooled to 40° C. or less.

After cooling, 4 g of a 1 N aqueous hydrochloric acid solution was added to the suspension. The suspension was agitated for 1 hour to an extent that the suspension flowed (specifically, using a three-one motor and a propeller impeller at 200 rpm), filtered and dried, whereby toner base particles were obtained.

### (Addition of Additive)

An amount 1.5 g of a silica (HVK2150: manufactured by Clariant) was added to 150 g of the toner base particles thus obtained, and the mixture was agitated and mixed using a MECHANOMILL (manufactured by OKADA SEIKO CO., LTD.) at 2500 rpm for 5 minutes, whereby a non-magnetic single-component positively chargeable toner was obtained.

### Example 4

The same procedures as in Example 1 were performed except that the mixing ratio of organic solvent to pure water was as shown in Table 1, and pure water and methyl ethyl ketone were mixed in the steps of preparing an oil medium and an aqueous medium, to thereby produce a toner.

### Examples 5 and 6

The same procedures as in Example 1 were performed except that tetrahydrofuran was used as the organic solvent in place of methyl ethyl ketone; the mixing ratio of the organic solvent to the pure water was as shown in Table 1 in the step of preparing an oil medium; 18 g of a 1 N aqueous sodium hydroxide solution was added in the step of preparing an aqueous medium; the resin microparticle in the suspension was found to have a volume average diameter (median size) of 429 to 460 nm, and the suspension was found to have a solid content of 21.5% by weight to 23.0% by weight in the step of preparing a suspension; and 50 g of a 0.2 N aqueous aluminium chloride solution was added and the suspension was heated to 43° C. in the water bath, and 70 g of a 0.2 N aqueous sodium hydroxide solution was added in the aggregation/fusion step, to thereby produce a toner.

### Example 7

The same procedures as in Example 5 were performed except that the mixing ratio of organic solvent to pure water was as shown in Table 1, and pure water and tetrahydrofuran were mixed in the steps of preparing an oil medium and an aqueous medium, to thereby produce a toner.

### Comparative Examples 1 and 2

The same procedures as in Example 1 were performed except that the mixing ratio of methyl ethyl ketone to water was as shown in Table 1 in the step of preparing an oil medium, to thereby produce a toner.

### Comparative Examples 3 and 4

The same procedures as in Example 5 were performed except that the mixing ratio of tetrahydrofuran to water was as shown in Table 1 in the step of preparing an oil medium, to thereby produce a toner.

TABLE 1

| | | | | | | Aqueous Medium | | |
|---|---|---|---|---|---|---|---|---|
| | | Oil Medium | | | | | | Content |
| | | | | Water | No. of Parts | | | of Organic |
| | Organic | Organic | Pure | Content | of Water | Pure | Organic | Solvent |
| | Solvent | Solvent (g) | Water (g) | (wt. %) | (p/wt) | Water (g) | Solvent (g) | (wt. %) |
| Ex. 1 | MEK | 693 | 99 | 12.5 | 14.3 | 801 | 0 | 0 |
| Ex. 2 | MEK | 693 | 77 | 10.0 | 11.1 | 823 | 0 | 0 |
| Ex. 3 | MEK | 693 | 36.5 | 5.0 | 5.3 | 863.5 | 0 | 0 |
| Ex. 4 | MEK | 641.4 | 71.3 | 10.0 | 11.1 | 829 | 51.3 | 5.83 |
| Comp. Ex. 1 | MEK | 693 | 28.8 | 4.0 | 4.2 | 871.2 | 0 | 0 |
| Comp. Ex. 2 | MEK | 693 | 0 | 0.0 | 0 | 900 | 0 | 0 |
| Ex. 5 | THF | 693 | 132 | 16.0 | 19.0 | 768 | 0 | 0 |
| Ex. 6 | THF | 693 | 36.5 | 5.0 | 5.3 | 863.5 | 0 | 0 |
| Ex. 7 | THF | 675.2 | 50 | 6.9 | 7.4 | 850 | 18 | 2.07 |
| Comp. Ex. 3 | THF | 693 | 152 | 18.0 | 21.9 | 748 | 0 | 0 |
| Comp. Ex. 4 | THF | 693 | 28.5 | 4.0 | 4.1 | 871.5 | 0 | 0 |

### Evaluation of Toner

### (Particle Size Distribution)

Values of average particle diameter by volume Dv of the obtained toner and of Dv/Dn (average particle diameter by number) serving as an index of uniformity in particle size are shown in Table 2. The particle size distribution of the toner was determined using a Coulter Multisizer II (manufactured by Beckman Coulter, Inc.). The analyzer with an aperture diameter of 100 μm was used. About 0.2 g of the obtained toner and 20 ml of an aqueous solution containing a 0.01 wt % surfactant (PELEX OT-P; manufactured by Kao Corporation) were mixed and then dispersed with an ultrasonic cleaner to prepare a dispersion. About three drops of the obtained dispersion were supplied into the analyzer using a 2-ml dropping pipet to determine the particle size distribution of the toner.

TABLE 2

| | Dv (μm) | Dv/Dn |
|---|---|---|
| Ex. 1 | 8.5 | 1.15 |
| Ex. 2 | 8.7 | 1.16 |
| Ex. 3 | 8.6 | 1.18 |
| Ex. 4 | 8.7 | 1.14 |
| Comp. Ex. 1 | 8.5 | 1.15 |
| Comp. Ex. 2 | 8.6 | 1.18 |
| Ex. 5 | 9.2 | 1.25 |
| Ex. 6 | 8.9 | 1.24 |
| Ex. 7 | 9.0 | 1.21 |
| Comp. Ex. 3 | 9.3 | 1.24 |
| Comp. Ex. 4 | 8.7 | 1.22 |

### (Coloring State of Toner)

The blackness of the obtained toner itself was evaluated as an index of pigment dispersibility in the toner particle.

Specifically, 2 g of the toner base particles before addition of an additive were collected, the collected toner base particles were charged into a compression pressing machine (BRIQETTING PRESS BRE-30; manufactured by MAEKAWA MACHINE MFG), and then compressed at 60 kN for 2 minutes to obtain a (circular) pellet having a diameter of 40 mm.

The reflection density of the obtained pellet was measured using a reflective densitometer (TR914; manufactured by Macbeth Process Measurements Co.). A total of 9 points including 1 point at a center of the pellet and 8 points near the periphery thereof were measured and then averaged. The average result was determined as an index of pigment dispersibility. When the average value was 1.60 or more, it was able to be judged that the toner base particles appeared visibly black. The results are shown in Table 3.

TABLE 3

| | No. of Parts of | Blackness of Toner |
|---|---|---|
| | Water (p/wt) | (Reflection Density) |
| Ex. 1 | 14.3 | 1.60 |
| Ex. 2 | 11.1 | 1.61 |
| Ex. 3 | 5.3 | 1.60 |
| Ex. 4 | 11.1 | 1.63 |
| Comp. Ex. 1 | 4.2 | 1.42 |
| Comp. Ex. 2 | 0 | 1.40 |
| Ex. 5 | 19.0 | 1.61 |
| Ex. 6 | 5.3 | 1.60 |
| Ex. 7 | 7.4 | 1.63 |
| Comp. Ex. 3 | 21.9 | 1.41 |
| Comp. Ex. 4 | 4.1 | 1.39 |

### (Optical Density of Toner)

The toner obtained in each of Examples and Comparative Examples was charged into a developer cartridge of a printer (HL-1850; printing speed: 18 ppm; manufactured by Brother Industries, Ltd.), three sheets of print samples of which a square solid portion (solid patch) was printed on the four corners were printed out, and the optical density of each of the solid patches was measured.

Each solid patch has a size of 25 mm per side, and Xerox 4200 (A4 size) paper was used. A reflective densitometer (TR914; manufactured by Macbeth Process Measurements Co.) and a transmission densitometer (TD904; manufactured by Macbeth Process Measurements Co.) were used to measure the optical density, and the reflection density and the transmission density were measured as the optical density. Further, the image quality was visually judged. The criteria of judgment for image quality are shown below.

The optical density was measured at five points (four corners and a center) per solid patch, and the average of those points on the three sheets of print samples was adopted as a typical value of the optical density. Only the solid patch on the upper left corner was measured to determine the optical density. The results are shown in Table 4.

TABLE 4

| | | Optical Density | | | |
|---|---|---|---|---|---|
| | No. of Parts of | Reflection | Transmission | | Amount of |
| | Water (p/wt) | Density | Density | Image Quality | Toner (mg) |
| Ex. 1 | 14.3 | 1.45 | 1.90 | B | 3.5 |
| Ex. 2 | 11.1 | 1.45 | 1.91 | B | 3.4 |
| Ex. 3 | 5.3 | 1.44 | 1.90 | B | 3.5 |
| Ex. 4 | 11.1 | 1.46 | 1.93 | A | 3.6 |
| Comp. Ex. 1 | 4.2 | 1.35 | 1.85 | C | 3.5 |
| Comp. Ex. 2 | 0 | 1.33 | 1.82 | C | 3.5 |
| Ex. 5 | 19.0 | 1.45 | 1.90 | B | 3.5 |
| Ex. 6 | 5.3 | 1.44 | 1.89 | B | 3.7 |
| Ex. 7 | 7.4 | 1.46 | 1.92 | A | 3.6 |
| Comp. Ex. 3 | 21.9 | 1.32 | 1.85 | C | 3.5 |
| Comp. Ex. 4 | 4.1 | 1.31 | 1.83 | C | 3.6 |

### Image Quality:

A: Generation of fog was not observed by visual inspection, and no density unevenness exists on the solid patch.
B: Generation of fog was scarcely observed by visual inspection, or density unevenness exists on a small portion of the solid patch.
C: Generation of fog was slightly observed by visual inspection, or, density unevenness exists on the entire solid patch.

When comparisons are made to evaluate the optical density of the toner, the amount of the toner developed on the sheet should be constant. Since a commercially available printer was used for such evaluation, whether or not the optical density thereof was compared with the same amount of toner needs to be checked.

The following test was conducted to check the amount.

That is, the fixing assembly was removed from the printer and an unfixed print sample was collected. The solid patch (only the solid patch on the upper left corner) on the unfixed print sample was cut out with scissors, and the weight thereof was measured with a precision electric balance. Thereafter, unfixed toners on the paper sheet were blown off by air. The weight of the paper sheet after those toners were removed was measured, and the weight of the developed toner was calculated by subtracting the weight of the paper sheet after the removal of the toners from the weight of the solid patch on the unfixed print sample.

Similarly, the weight of the developed toner on each of the three sheets of printed samples was measured. The results confirmed that, as for all the toners obtained in Examples 1 to 4 and Comparative Examples 1 and 2, the developed toner had a weight in the range of 3.4 to 3.7 mg, so that almost the same amount of toner was used to compare the optical density.

The embodiments described above are illustrative and explanatory of the invention. The foregoing disclosure is not intended to be precisely followed to limit the present invention. In light of the foregoing description, various modifications and alterations may be made by embodying the invention. The embodiments are selected and described for explaining the essentials and practical application schemes of the present invention which allow those skilled in the art to utilize the present invention in various embodiments and various alterations suitable for anticipated specific use. The scope of the present invention is to be defined by the appended claims and their equivalents.

What is claimed is:

1. A method for producing a toner comprising the steps of:
preparing a resin liquid by mixing at least a binder resin made of polyester resin and a colorant with an organic solvent;
dispersing the resin liquid in an aqueous medium to form an emulsion; and
removing the organic solvent from the emulsion to produce a toner,
wherein the organic solvent before preparation of the resin liquid contains 5 to 20 parts by weight of water per 100 parts by weight of the organic solvent.

2. The method for producing the toner according to claim 1, wherein the organic solvent is removed from the emulsion to prepare a suspension, and the suspension is subjected to aggregation and fusion.

3. The method for producing the toner according to claim 1, wherein the aqueous medium comprises an organic solvent mixed with water.

4. The method for producing the toner according to claim 1, wherein the organic solvent is a ketone or an ether.
